(19) United States
(12) Patent Application Publication
(10) Pub. No.: US 2005/0096975 A1
(43) Pub. Date: May 5, 2005

(54) Method and system for interactive advertisement

(76) Inventor: Eliahu Moshe, Herzeliya (IL)

Correspondence Address: NATH & ASSOCIATES, PLLC, Sixth Floor, 1030 15th Street, N.W., Washington, DC, 20005, US

(21) Appl. No.: 10/700,476

(22) Filed: Nov. 5, 2003

(51) Int. Cl. G06F 17/60

(52) U.S. Cl. 705/14

(57) ABSTRACT

There is provided a computerized method and system for providing interactive advertisement. A method according to an embodiment of the invention comprising the following stages: providing a repertoire of incentives; providing a gateway and at least two mini-sites, each including promotional content associated with at least one incentive from among the repertoire of incentives; dynamically monitoring at least consumer's activities in respect of selected promotional content in at least one of the mini-sites and providing a rank, and depending upon at least the rank, selectively associating at least one incentive with promotional content.

### FIELD OF THE INVENTION

This invention relates to a system and method for interactive advertisement of the kind suitable to be implemented over communication networks such as the Internet, cable and interactive TV.

### BACKGROUND OF THE INVENTION

Interactive advertisement today is a vast and profitable field, in which new technologies are used to advance the promotional efforts of companies and increase sales of products or services. U.S. patent application Ser. No. 09/818,020 discloses one such system for facilitating the sale, reservation, purchase, management and creation of electronic advertisements.

The system disclosed in U.S. patent application Ser. No. 09/818,020 enables site owners of digital signs to establish and maintain seasons of operation for their signs, having rates and promotions which may differ for each season, day or time, and control the use of their digital signs by advertisers by a specific approval process. Advertisers are assisted in forming and managing advertising campaigns having reservations for the presentation of electronic advertisements at different sites, on different days, at different times, and for different advertisements that may be created by the system using an ad builder process or that may already exist and be uploaded to or referenced by the system. Consumers are provided with the ability to readily locate further information relevant to products or services viewed in advertisements, and purchase such products or services using electronic payment options.

The exemplary system disclosed in U.S. patent application Ser. No. 09/818,020 provides advertisers with interactive capabilities, wherein consumers have a more passive role. Contrary to this approach, other interactive systems are known in which consumers have a more active role and are directed to interact with the system. Among other promotional efforts, companies today conduct incentive programs over communication networks in which individual consumers are offered incentives such as awards, games, prize draws, best deals, discount coupons and the like, in order to direct consumers toward actions such as viewing advertisements, visiting a retail site, registering with consumer clubs, and more.

U.S. Pat. No. 6,173,267 discloses a method for providing fulfillment in a promotional contest, which includes providing a card in a product package marked with an Internet address and a password. The purchaser of the product contacts the Internet address and inputs personal information and the password to learn if the purchaser is a winner in the contest. If the purchaser is a winner, the card is sent to the company to verify the winning status before sending the prize to the purchaser.

U.S. Pat. No. 6,267,672 discloses a remotely accessible game, such as an Internet game, to encourage consumers to purchase a product. Consumers who purchase a product receive access information which the consumer may then use to access and participate in a remotely accessible game. The pleasure of participating in the game is in and of itself an incentive to consumers to purchase products. The remotely accessible game may comprise a plurality of levels of varying degrees of difficulty so that participating consumers may continue to be challenged as they gain mastery of the game. Consumers who access the remotely accessible game may become eligible for prizes. Further, the interactive nature of the remotely accessible game allows for the collection of valuable demographic and marketing information from consumers who participate in the game.

U.S. Pat. No. 6,251,017 discloses a method for conducting a promotional game or lottery in which the awards are accessed to one or more predetermined internet-based services or sites. Validation codes are distributed to consumers on game cards or purchase receipts. The validation code is entered into a computer, which is communicatively connected to the Internet, and a number of e-points are awarded if the input validation code matches one of a plurality of validation codes stored at a remote site. The e-points are a measure of the amount of a benefit which is spent like money or elapses like time in response to the usage of a designated internet service or site. The greater the number of e-points, the greater the benefit conferred upon the player. The e-points are exchangeable for limited access to the designated sites or services on the Internet. The magnitude of the e-point reward may be based upon purchase transactions made in a retail store. Also disclosed is a method for encouraging a consumer to go online and visit one or more designated internet sites and thereafter receive a benefit at a store, but only if the consumer first registers the validation code at one or more of the designated internet site(s).

U.S. Pat. No. 6,061,660 discloses an interactive method and system for providing incentive programs over a computer network, in which a host may (a) provide sponsoring companies with the capability to buy prepackaged or self-built incentive programs, (b) offer such incentive programs to consumers, (c) provide sponsoring companies and retailers with the capability to associate prizes with incentive programs, (d) provide sponsoring companies, retailers and is consumers with convenient fulfillment of prizes, and (e) store and manipulate databases regarding all of the foregoing.

Typically, interactive systems like the one disclosed in U.S. Pat. No. 6,061,660 includes inter alia, systems for interfacing with consumers, sponsoring companies and retailers, as well as for management. Generally speaking, interactive systems are configured to run both consumers' and sponsors' modules to allow the interactive activities of consumers and sponsors, as well as management modules to manage the foregoing. Such systems are aimed at offering consumers with incentive programs in which the promotional content of the sponsoring companies is associated with incentive activities. The sponsoring companies are allowed to provide the content of the incentive program (e.g. advertisement or promotional content relating to the company's brand or to a specific product or service). The promotional content is associated with the incentive activities, which are offered to the consumers.

Normally, the incentives are financed by the sponsoring companies and the retailers. For example, in U.S. Pat. No. 6,061,660, the system allows the sponsors to select the prize to be associated with their promotional content, for example, to determine the type of prize and its monetary value, the frequency of winning, etc. The sponsors are requested to pay for the incentives and for the services the system offered the providers (buying or building an incentive program, querying data, etc.).

### SUMMARY OF THE INVENTION

The present invention provides a computerized system and method for interactive advertisement of the kind suitable to be implemented over communication networks such as the Internet, cable and interactive TV. The present invention provides individual consumers with a computer based, interactive environment, in which promotional content offered by sponsoring companies is associated with incentive activities. The present invention provides sponsoring companies with computerized, interactive tools for conducting promotional actions (so-called campaigns). The present invention constitutes a computerized system and method which serves as a portal, i.e., gateway to a virtual environment (e.g. the Internet, cable or interactive TV), in which the interactive activities performed by all participants are carried out. The activities carried out by the consumers (or part thereof) are monitored, and the system allows the operator and/or the sponsors to change the allocation of incentives in the campaigns and therebetween.

The term “consumer” includes an individual, a private person (for example an Internet surfer or a TV viewer) who participates in an incentivized activity that is offered to him via the system of the invention. Typically but not necessarily, this person is a costumer or a potential consumer of the sponsoring company. In other words, the consumer already purchased a product or service of the sponsoring company, or is a potential purchaser thereof.

The term “sponsoring company” or “sponsor” includes brand companies, governmental agencies, advertisement agencies, or even private persons. Famous and global brand companies such as Coca-Cola™, Nokia™ and Volvo™ can sponsor incentive programs, as can local companies or governmental agencies. The invention is not limited by the kind of sponsoring company, which can be any other entity that wishes to promote its product or a service. The term “sponsoring company” also relates to an advertising agency that wishes to promote a variety of products and services, that originate from one or possibly more than one different companies. The term “sponsoring company” or “sponsor” also includes a retailer who provides goods (or services) that can be won or bought through the system according to an embodiment of the invention.

The term “promotional content” includes design, name, product or service, which can be expressed e.g. by visual, text, audio or any other means used in advertisements to promote brand names, products or services. In an Internet environment, exemplary promotional content refers to, for example, images used to format the layout of a web page, banners, interactive games and other activities, flash animations, video/audio cuts and the like.

The term “incentives” includes monetary, monetary-equivalent incentives, design-related incentives, activity-related incentives and other incentives which are offered a consumer in order to direct him/her toward a desired activity such as accessing a specific site, viewing a specific promotional content, registering with a consumers' club, and participating in an interactive activity (e.g. game, competition or prize draw). The monetary incentives may include e.g. monetary and monetary-equivalent awards in games, competitions and prize draws, best deal offers, discount vouchers, coupons, gift certificates and the like. The incentives can relate to the value of the prizes, the rate of discounts, the number, type, and quality of prizes, the frequency of winning, and the like.

The incentive can relate to the interactive activity itself, as the pleasure and amusement of participating in the interactive activity by itself may serve as an incentive. In order to provide the consumer with a pleasurable experience, the interactive activities may offer highly appealing design/graphics and be challenging in complexity, both elements being constantly updated to maintain consumers' interest.

Incentives are associated with promotional content in a variety of ways, for example, by allocating an interactive game to a specific sponsor; by the sponsor offering a competition with monetary prizes, by creating a creative game centered about a specific product or brand, and the like. Design related incentives are associated with promotional content for example, by locating a banner or an icon in a web page, by changing the design of the banner or icon or the page itself, and the like.

It should be noted that according to an embodiment of the invention, a specific promotional content that, for example, relates to a specific product, can be associated with more than one interactive activity. For example, the promotional content can relate to a specific telephone model (say, Nokia™), and can be associated with an incentive activity such as a game in which the prize is an amount of air-time, and, at the same time, a competition in which the prize is a telephone device of a specific model.

It is commonly known that computerized ventures and specifically Internet-based projects are challenged to be friendly and appealing to users. Thus, it is known in prior art systems and methods to facilitate an appealing user experience, for example, by providing short and efficient registration procedures, or by offering creative design to web pages and activities. The design by itself can provide incentives for consumers to perform a specific action.

The present invention addresses the challenge of appealing in a novel manner, according to which activities carried out in the system are continuously monitored, and the incentives are dynamically allocated between the different activities, in order to enhance the efficiency of the promotional actions and achieve synergism therebetween. According to the present invention, a management system continuously monitors the operations and activities carried out by the consumers and sponsors, and dynamically rank activities according to a ranking policy. Depending upon the resultant rank, the incentives are dynamically allocated between the different activities, i.e., associated with the promotional content, in order to enhance the efficiency of the promotional actions and achieve synergism therebetween. In other words, according to an embodiment of the invention, the activities carried out at least by the consumers are monitored and the respective usage of the system is dynamically ranked, and in response, the incentives are dynamically associated with promotional content.

The dynamic association of incentives with promotional content can be achieved in various ways, for example, by changing the monetary value of the prizes, the frequency of winning, the kind, type and monetary value of the discount rate, the type, kind, design, graphics and complexity of a game, the size of the icon relating to a specific activity, the location of that icon on the menu, and the like.

The method and system according to the present invention can be operated in integration with advertisement campaigns run via other media (e.g. on billboards and in newspapers, advertisement clips for movies and TV, etc.). For example, the timing of the campaigns run by the system of the invention can be synchronized with that of a “real world” campaign; a “real world” advertisement can promote the portal of the system of the invention and vice versa, etc. The present invention can also be implemented without being related to any “real world” campaign.

According to an embodiment of the invention, there is provided a computerized method for providing interactive advertisement, comprising: (a) providing a repertoire of incentives; (b) providing a gateway and at least two mini-sites, each including promotional content associated with at least one incentive from among said repertoire of incentives; and (c) dynamically monitoring at least consumer's activities in respect of selected promotional content in at least one of said mini-sites and providing a rank, and, depending upon at least said rank, selectively associating at least one incentive with promotional content.

According to an embodiment of the invention, the repertoire of incentives may include at least one of the following: monetary incentives, design-related incentives, activity related incentive. The monetary incentives may include at least one of the following: monetary awards in at least one of: interactive games, competitions and prize draws; discount vouchers; and purchase vouchers. The design-related incentives may include at least one of: icons, banners, page design, which may be associated with promotional content located in at least one of the following: the gateway; the mini site/s or at a remote site. The activity related incentives include at least one of the following: participation in a game, participation in a prize draw, participation in a competition, registering to consumers' club, accessing a site, downloading a ringtone, downloading wallpaper, downloading a screensaver.

According to an embodiment of the invention, said consumers' activity includes at least one parameter of: accessing said gateway, accessing said mini site, accessing a remote site, game participation, prize draw participation, returned mini-site entry, active action, action indicating intent to buy, and buying action. These parameters are considered such that a rank is provided, said rank being a weighted function of at least one of the above listed parameters of consumers' activity, wherein each parameter is rated according to a predetermined manner and weighted by using a predefined weight factor, which can be changed on-the-fly.

In accordance with an embodiment of the invention, said selectively associating at least one incentive with promotional content includes at least one of the following: associating an incentive with said promotional content, wherein said incentive is already associated with another promotional content; updating the monetary value of a monetary incentive already associated with said promotional content; at a site other than said mini-site, allocating an incentive with said promotional content; and said one incentive replacing an incentive already associated with said promotional content.

According to yet another embodiment of the invention, the monetary incentive is a monetary award or a monetary-equivalent award offered in relation to at least one of: a game, a competition, a prize draw, a discount voucher or a purchase voucher; and said updating the monetary value of said award includes at least one of: increasing the monetary value of said award; and increasing the frequency of winning of said award.

There is also presented a system for providing interactive advertisement, comprising: a network; a host computer connected to the network for providing a repertoire of incentives and for providing a gateway and at least two mini-sites, each including promotional content associated with at least one incentive from among said repertoire of incentives; a consumer computer connected to the network for allowing a consumer performing consumer activities in respect of selected promotional content in at least one of said mini-sites; a resource management module connectable to said host for dynamically monitoring said consumer's activities and providing a rank, and depending upon at least said rank, selectively associating at least one incentive with promotional content.

The system according to the invention can be implemented over a network including the Internet, cable network, or an interactive TV network. The system can be further implemented such that the consumer computer is a mobile communication device or a personal computer.

According to yet another embodiment of the invention, the system comprises a sponsor computer connected to the network, and is further configured to provide as an output the above-mentioned rank and receive as an input instructions for associating at least one incentive with promotional content. In the above configuration, the sponsor can receive the rank outputted by the system, and convey the system instructions for fulfilling an advertising policy which, in turn, will be inputted by the system and used for associating incentives with promotional content.

According to another embodiment of the invention, there is provided a method for increasing customers' activities in an interactive advertisement portal for fulfilling a promotional campaign run by at least two sponsors, the method comprising: (a) providing a first action enabling a repertoire of incentives; (b) providing a second action enabling at least two mini-sites; each mini-site including promotional content relating to at least one of said promotional campaigns run by a sponsor, said promotional content being associated with at least one incentive from among said repertoire of incentives; (c) charging said sponsors for said first action and second action; and (d) collecting payments from sponsors, and, based on at least said payments, providing additional monetary incentive and associating said additional monetary incentive with promotional content relating to at least two promotional campaigns. According to an embodiment of the invention, stage (c) further includes: monitoring consumers' activities in respect of selected promotional content in said mini-sites and charging said sponsors for said second action in dependence with said consumers' activities.

According to yet another embodiment, there is also provided a method for increasing customers' activities in an interactive advertisement portal for fulfilling promotional campaigns run by at least one sponsor, comprising: (a) providing a plurality of mini-sites in said portal; each mini-site associated with at least one of said sponsors and campaigns; a mini-site including promotional content associated with at least one incentive from a repertoire of incentives; (b) charging at least one sponsor for either or both the promotional content and the associated incentive, giving rise to a charge per mini-site; and (c) accumulating said charge per mini-site from selected mini-sites from said plurality of mini-sites, giving rise for a total sum usable for increasing monetary incentives.

According to an embodiment of the invention, there is provided a program storage device readable by machine, tangibly embodying a program of instructions executable by the machine to perform method steps for providing interactive advertisement, comprising: (a) providing a repertoire of incentives; (b) providing a gateway and at least two mini-sites, each including promotional content associated with at least one incentive from among said repertoire of incentives; (c) dynamically monitoring at least the consumer's activities in respect of selected promotional content in at least one of said mini-sites and providing a rank, and depending upon at least said rank, selectively associating at least one incentive with promotional content.

According to yet another embodiment of the invention, there is provided a computer program product comprising a computer useable medium having computer readable program code embodied therein for providing interactive advertisement, the computer program product comprising: computer readable program code for causing the computer to provide a repertoire of incentives; computer readable program code for causing the computer to provide a gateway and at least two mini-sites, each including promotional content associated with at least one incentive from among said repertoire of incentives; and computer readable program code for causing the computer to dynamically monitor at least the consumer's activities in respect of selected promotional content in at least one of said mini-sites and providing a rank, and depending upon at least said rank, selectively associating at least one incentive with promotional content.

According to yet another embodiment of the invention there is provided a program storage device readable by machine, tangibly embodying a program of instructions executable by the machine to perform method steps for increasing customers' activities in an interactive advertisement portal for fulfilling promotional campaigns run by at least one sponsor, comprising: (a) providing a plurality of mini-sites in said portal; each mini-site associated with at least one of said sponsors and campaigns; mini-site including promotional content associated with at least one incentive from a repertoire of incentives; (b) charging at least one sponsor for either or both the promotional content and the associated incentive, giving rise to a charge per mini-site; and (c) accumulating said charge per mini-site from selected mini-sites from said plurality of mini-sites, giving rise to a total sum usable for increasing monetary incentives.

According to another embodiment of the invention, there is provided a computer program product comprising a computer useable medium having computer readable program code embodied therein for increasing customers' activities in an interactive advertisement portal for fulfilling promotional campaigns run by at least one sponsor, the computer program product comprising: computer readable program code for causing the computer to provide a plurality of mini-sites in said portal; each mini-site associated with at least one of said sponsors and campaigns; mini-site including promotional content associated with at least one incentive from a repertoire of incentives; computer readable program code for causing the computer to charge at least one sponsor for either or both the promotional content and the associated incentive, giving rise to a charge per m-site; and computer readable program code for causing the computer to accumulate said charge per mini-site from selected mini-sites from said plurality of mini-sites, giving rise for a total sum usable for increasing monetary incentives.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic generalized system configuration according to an embodiment of the invention;

FIG. 2 is a more detailed schematic illustration of the system of FIG. 1;

FIG. 3 is a schematic flow chart showing stages that are carried out by a consumer according to an embodiment of the invention;

FIG. 4 shows schematically a main menu of a portal according to an embodiment of the invention;

FIG. 5 shows schematically a web page according to an embodiment of the invention;

FIGS. 6a-6e show web pages available at the official Canadian website of Kinder Surprise™ (at http://www.kindersurprise.com/english/index.html);

FIG. 6f shows the full content of the “Kinder Kontest™” rules as partially shown in FIG. 6c.

FIG. 7 illustrates schematically an exemplary data structure for storing data relating to the usage of a system according to an embodiment of the invention;

FIG. 8 illustrates schematically an interface for defining a rank for usage of the system according to an embodiment of the invention;

FIG. 9 illustrates schematically a simulation of the rank for the usage of a system according to an embodiment of the invention;

### DETAILED DESCRIPTION OF THE INVENTION

The present invention provides a computerized system and method for interactive advertisement of the kind suitable to be implemented in a virtual environment over communication networks such as the Internet, cable and interactive TV. In order to simplify the explanations and without limitation, the following description relates mainly to an embodiment of the invention that is best implemented in an Internet based communication network.

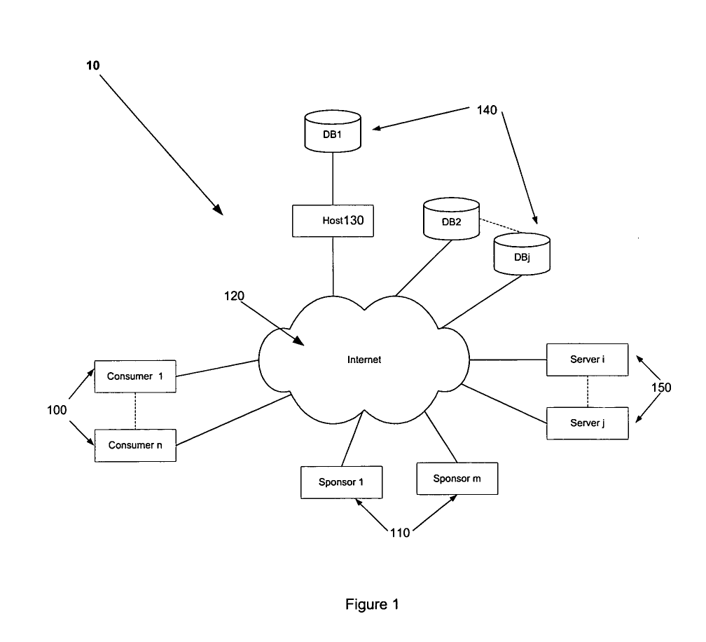

FIG. 1 is a schematic generalized system 10 configuration according to an embodiment of the invention, in which consumers' computers 1 to n 100 and sponsors' computers 1 to m 110 are connected through Net 120 to a host computer 130, in the known ‘client-server’ model. The host computer 130 is e.g. a server connectable to databases DB1 (via a direct connection) and DB2 to DBi 140 (via the Net 120), and perhaps to computers 1 to j 150. Computers 100, 110, 130, 140 and 150 are preferably personal computers, or dedicated terminals capable of on-line communication with a host server. Specifically, the invention may be operable with consumers' computers being portable cellular phones, PDAs (Personal Digital assistant), portable PC or any other mobile communication device equipped with browsing capabilities.

System 10 provides individual consumers (via consumers' computers 100) with access to interactive web site/s in which promotional content offered by sponsoring companies is associated with incentives. System 10 further provides sponsoring companies (preferably via sponsors' computers 110) with computerized, interactive tools for conducting promotional actions.

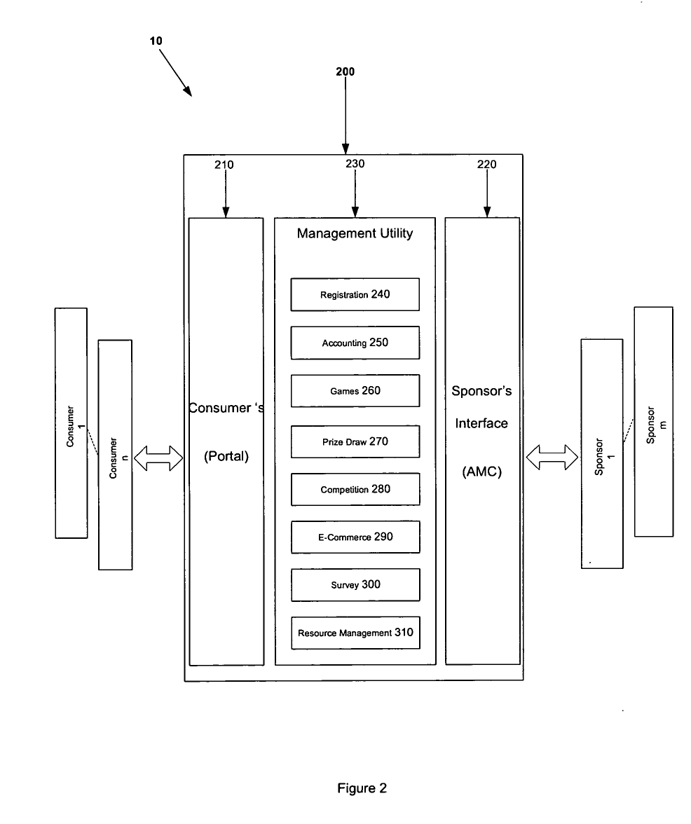

FIG. 2 is a more detailed schematic illustration of system 10 of FIG. 1. Computer 130 of FIG. 1 constitutes, either alone or with the aid of servers 150 (not shown in FIG. 2), the host 200 of the system 10. The host 200 provides a host gateway, (namely, a portal) which is functionally illustrated by consumer's interface 210 and the sponsors' interface 220. The host 200 further includes a management utility 230, for providing, tracking and managing the various activities carried out by the system. According to an embodiment of the invention, the managing utility 230 is a hardware/software utility utilizing the common gateway interface “CGI” protocol to allow interactivity between a client and a host operating system through the World Wide Web via the Hyper Text Transfer Protocol (HTTP). The managing utility 230 includes modules such as Registration module 240, for consumers and sponsors registration; Accounting module 250 for managing consumers accounts as well as sponsors accounts; various incentive modules like Games module 260, Prize draws module 270, e-commerce module 280, and possibly more. Further included are Survey module 300 for providing information and analysis of the activities carried out in the system; and possibly additional modules that are not shown in FIG. 2. Note that the modules 240-300 (and other modules not specifically shown in FIG. 2) can be implemented such that those modules referring to consumers are operated separately or in integration with other modules referring to sponsors. According to an embodiment of the invention (not shown), the managing utility 230 comprises a consumers' managing utility and a sponsors' managing utility, each including modules such as registration, accounting, etc.

The system 10 of FIGS. 1 and 2 is interactive in that the consumers and the sponsors dynamically interact with the system in real-time. According to an embodiment of the invention, system 10 is interactive in a further manner, according to which the usage of different parts of the system (i.e. the consumers' activities) is monitored and managed in a dynamic manner. By this embodiment, this aspect is mainly controlled by the Resources management module 310, as will be described further below.

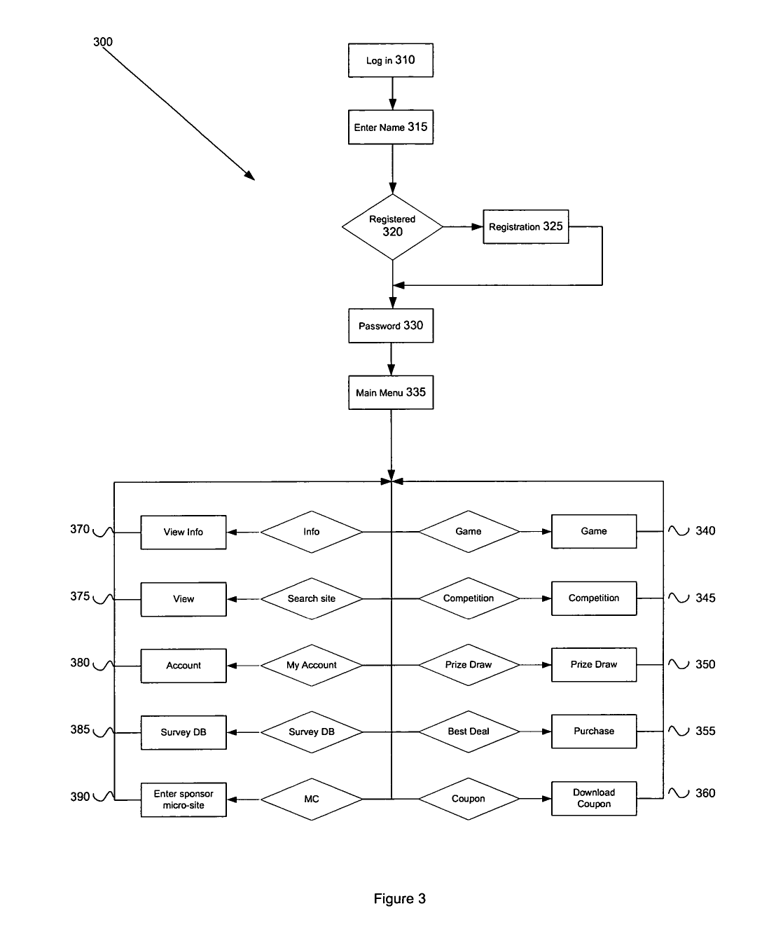

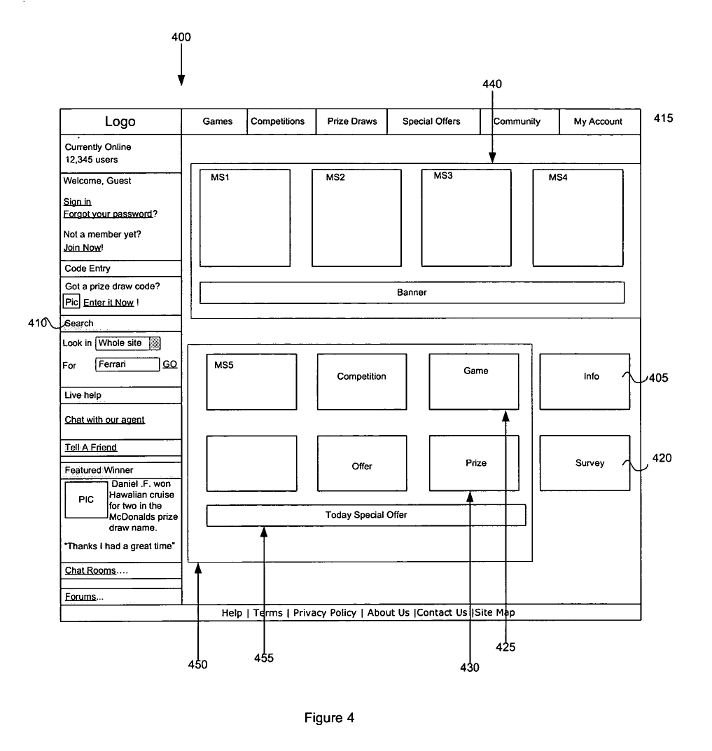

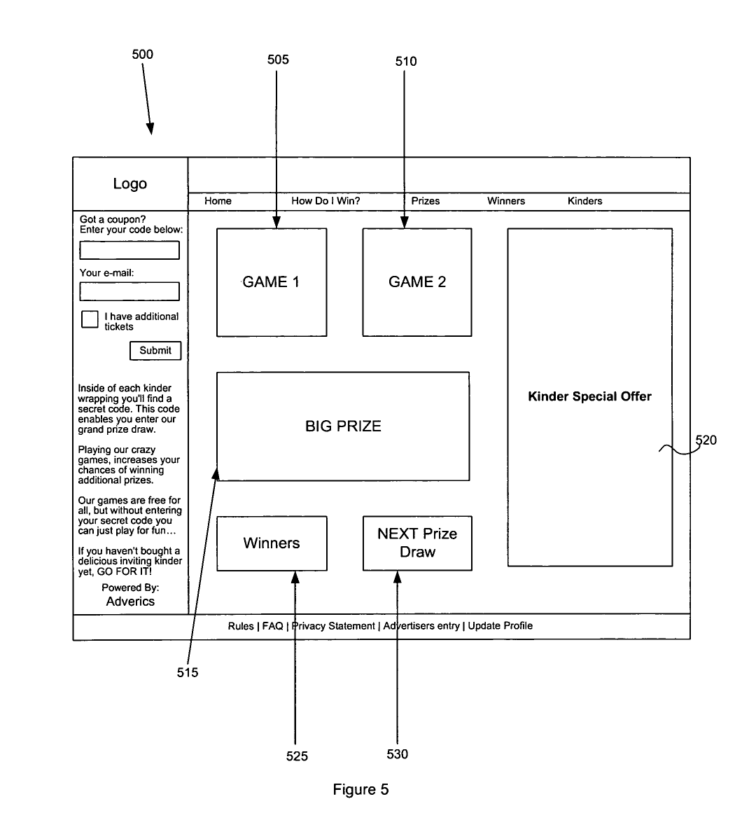

Referring to FIG. 3, there is illustrated a schematic flow chart showing stages 300 that are carried out by a consumer in order to participate in an interactive activity according to an embodiment of the invention. At step 310, the consumer logs into the system, for example by browsing to the system home page. The consumer enters his or her name (at 315) and if registration is needed (step 320), a registration procedure is performed (at 325). For security, at 330, the consumer is required to enter his code (e.g. personal password) and in 335 is offered a main menu. A schematic and non-limiting example of main menus 400 and 500 is shown in FIGS. 4 and 5 that will be discussed in detail below. Each of the functions 340-395 illustrated in the flow chart 300 can be initiated by selecting a hypertext link, button or graphical icon that describes the link, as appearing in FIGS. 4 and 5.

For explanation purposes only, the functions 340-395 can be categorized into three main groups. Note that the invention is not bound by these specific groups or the specific content of each group.

First group of functions: this group includes Game 340, Competition 345, Prize Draw 350, Best Deal 355 and Coupon 360 (icons 425, 430 in FIG. 4, icons 505-530 in FIG. 5). This group of functions is characterized in that each function 340-360 provides the consumer with a monetary or monetary-equivalent incentive. The implementation of incentives per-se is known, for example as detailed in U.S. Pat. Nos. 6,061,660, 6,251,017 and 6,267,672 incorporated here by reference. Therefore, the implementation of such incentives needs not to be fully described herein except to note the following.

Games and Competitions

Games and competitions provide important appeal to end users of any Internet site. Online games are generally required to be of a high quality and provide high entertainment value, and are typically implemented in Flash, Shockwave or Java.

According to an embodiment of the present invention, the games and competitions are provided to the consumers in HTML pages that also contain advertisement banners to be viewed by the consumer during playing.

According to another embodiment of the invention, the games and competitions are branded by themselves, i.e. contain advertising content integrated with the playful activity. For example, a game can focus on a Kinder Surprise™ egg. The consumer is challenged, for example, to move the egg along a rocky trail and avoid hitting the rocks or else the egg will break. According to another example, a competition is centered about Korona™ beer bottles and the player is challenged to insert lemon slices into the bottles.

Prize Draws

Several prize-draw enrollments that provide incentives for consumers and benefits for the sponsors are known and can be integrated in the system according to an embodiment of the invention, for example, as follows:
Registration only—no special action is required on the consumer's part, other than to specify his/her wish to participate. Since prize draws are available for registered consumers only, the company running the prize draw receives, in return for the prizes, the subscribing consumers' information and can use it for sending targeted email, or for snail mail advertising, telemarketing and SMS advertising.
Survey—consumers are required to answer an online survey in order to enroll in a prize draw. The survey results typically consist of valuable information for the company running the prize draw.
Correct answer—consumers are required to provide a correct answer to a single question.
Code entry—consumers are required to enter a code that is either imprinted on the product they purchase, or on a Prize Draw ticket they received in the store where they purchased products. Having entered the code in the portal, the consumers are enrolled to the prize draw. By entering several codes, consumers will have several entries into the prize draw, increasing their chances of winning. It is possible that the user, having entered a valid code, may still be requested to provide a correct answer.
E-Commerce: by buying online (via the system of the present invention or via other systems) a voucher with specified monetary value, or a Purchase Voucher of a product, or by performing a full-online transaction, users will automatically be enrolled in the prize draw.
Enrollment as a Reward—just playing a game and scoring a minimum specified score will grant consumers an additional prize draw enrollment in a significant prize draw they are already enrolled in (this can be implemented as a one-time reward per consumer, as a bonus). Performing operations such as informing a friend(s) about the system of the invention, or about a game or prize draw run by the system of the invention can be configured to reward the consumers by granting them enrollment entries into a significant prize draw, etc.

Best Deal (Purchase)

It is known to offer potential consumers the option of purchasing products via Internet sites, preferably at better prices than in real-world shops. According to an embodiment of the invention, this option is integrated in the system for attracting more customers and encouraging them to buy more products (or services).

Typically, users of Internet sites are offered fully-online transactions or online-offline transaction. In a fully-online transaction scheme, the consumer typically pays for the product online via credit card, directly to the merchant providing the product, and is not required to visit a real-world store to collect the product. The product is sent to the consumer for example via mail (such a scheme is offered for example, by Amazon.com and other sites).

According to an embodiment of the invention, the system of the invention is integrated with a dedicated e-commerce site (i.e. being part of the portal) or a well-known and already established e-commerce site in which the actual, fully-online transaction takes place. The main idea of such integration is to allow for real time and immediate handling of the transaction in both the e-commerce and prize-draw systems. For example, upon completion of the e-commerce transaction (e.g. after paying), the consumer is automatically granted with a prize draw enrollment.

Online-offline transactions are transactions in which the consumer pays for the product online via credit card, and receives a unique confirmation code that can be printed onto a voucher or emailed to him via the net. The consumer takes the confirmation code to an offline, real-world store and physically collects the item after presenting the confirmation code (this scheme is also available for pre-paid transactions utilizing portable communication devices to which the confirmation code is sent, for example, as an SMS message). The payment procedure can be handled by the merchant himself or by the system of the present invention. In the latter case, the merchant returns the confirmation code to the system and receives the money collected by system.

By operating Online-Offline transactions, the invention allows sponsors that have no e-commerce infrastructure, to broaden their activity and to operate not only in the real world (i.e. in their shops) but also in virtual environments (e.g. via an e-commerce system). The Online-Offline transactions utilize vouchers (also known as gift certificates), and the following schemes are offered to consumers for fulfilling Online-Offline transactions:
Monetary vouchers (gift certificates)—these vouchers can be of a variety of monetary values, and upon completing the purchase are mailed, emailed, or printable. The voucher allows the holder to purchase goods in a variety of real-world stores.
Purchase Vouchers—these vouchers differ from monetary vouchers in that they are provided by a specific sponsor(s), and grant the holder the option of receiving predefined goods (or services) displayed on the voucher from a real-world store.

According to an embodiment of the invention, the consumer is offered vouchers or gift certificates with the added incentive of being enrolled into a prize draw. Furthermore, the voucher can be emailed to a friend and serve as a gift, with the benefit of enrolling its beneficiary (or the purchaser) into a prize draw.

In addition to the first group of functions described above, the invention further provides the following functions, that for explanation purposes only, are divided into two groups, as follows:

Second group of functions: Reverting to FIGS. 3 and 4 and referring to management functions 370-385, the users of the system are provided with different common tools known per-se for viewing different kinds of information. Function 370 ‘info’ (icon 405 in FIG. 4) provides the user with access to information regarding, for example, competition rules or information about a specific product or service. Function 375 ‘search site’ (icon 410) allows the user to search, for example by keyword, topic, brand or other parameter, for a specific sponsor, product or activity. Function 380 ‘my account’ (icon 415) allows the user (e.g. the consumer), preferably in a secure manner, to view his account, to check if he won a prize in a prize draw, to examine his past activities, etc. Function 385 ‘survey database’ (icon 420) allows a user (e.g. a consumer, a sponsor or other user) to submit a query and view information stored therein.

Third group of functions: Function 390 MS (mini site) in FIG. 3 (and the corresponding icons 440 MS1 to MS5 in FIG. 4) stands for hyperlinks to mini-sites, which constitute a novel feature of the present invention. A mini-site is a virtual environment (e.g. a web site) in which interactive activities having benefits (incentives) for users are offered, such that all promotional content focuses on a single sponsor (e.g. a brand, a product, etc.). According to an embodiment of the invention, a mini-site is one site in a cluster of sites (at least two sites), all enveloped by a centralized system and accessible through at least one common gateway (portal). The activity of customers in the mini site are monitored (e.g. by monitoring usage parameters of the mini site) and managed by the centralized system. According to an embodiment of the invention, the association of incentives with the promotional content of a mini site of a specific sponsor is dynamically managed in response to the customers' activities in this mini site. According to another embodiment of the invention, the association of incentives with the promotional content of one mini site depends also on the activities carried out in another mini-site of the system or in the main menu of the portal. Furthermore, the dynamic association of incentives and promotional content can be carried out not only within the specific mini-site but rather throughout the system, specifically in the main menu of the portal and in other mini-sites within the system. This novel aspect of the present invention will now be demonstrated and explained.

Referring to FIG. 4, there are presented mini-site icons 440 MS1 to MS4, each associated with a specific sponsor, say for example, Kinder Surprise™, Volvo™, Coca-cola™ and a local food chain, respectively. Also presented is zone 450, constituting MS5, in which some of its functions can be initiated directly from the main menu 400. According to an embodiment of the present invention, MS5 is associated with the operator of the system, which can offer incentives like games, prize draws, competitions and today's offer (icons 425, 430, 455). In other words, the operator of the system runs its own mini site and may integrate the main menu of the operator's mini site with the main menu of the portal. Referring again to FIGS. 3 and 4, note that all three type of functions, namely, incentive functions 340-360, management functions 370-385 and mini-site functions 395 (icons 440 and zone 450) can be offered either on the main menu 400 or at the main menu of the mini-site (e.g. menu 500 in FIG. 5, as discussed below) or in both.

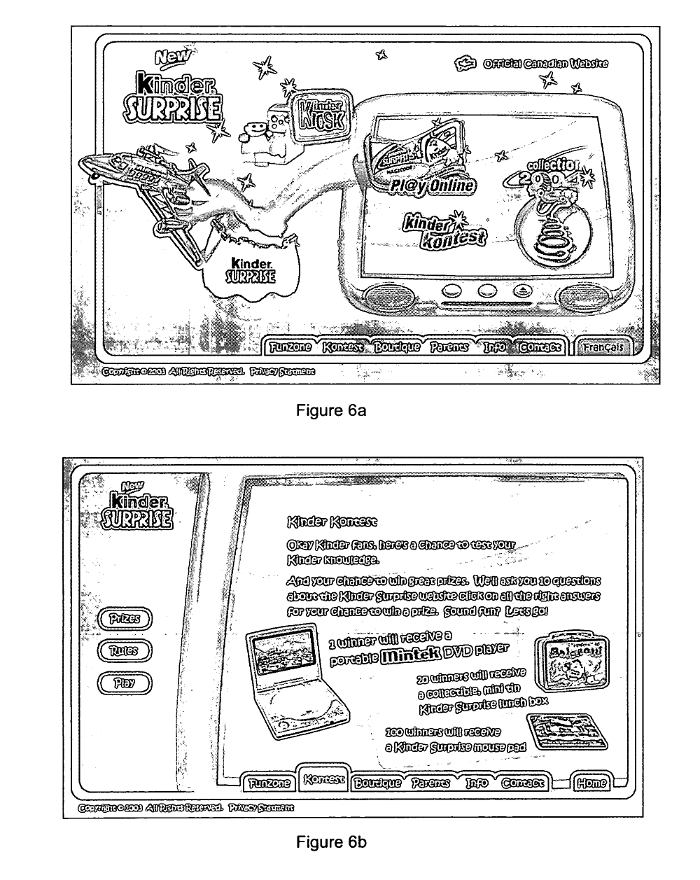

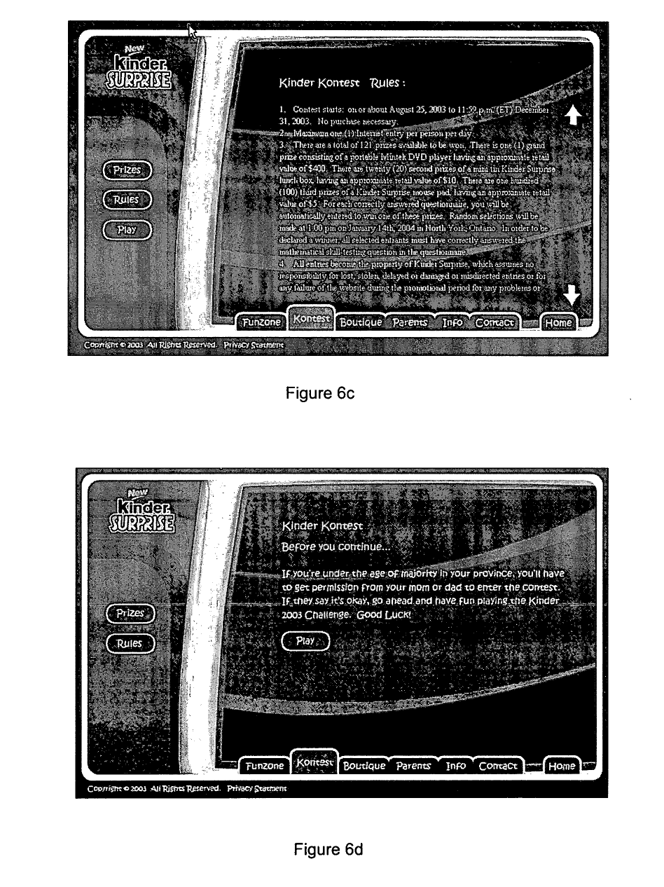

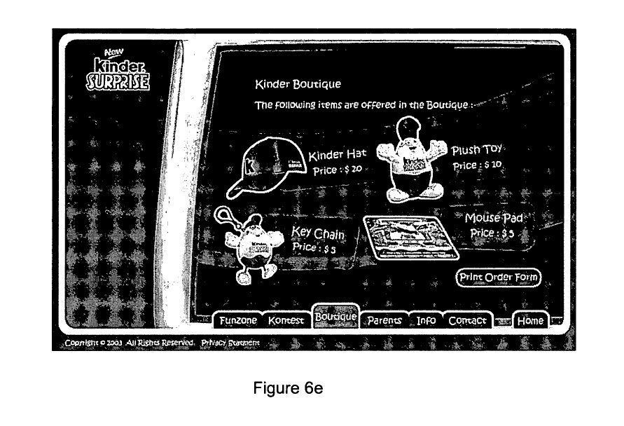

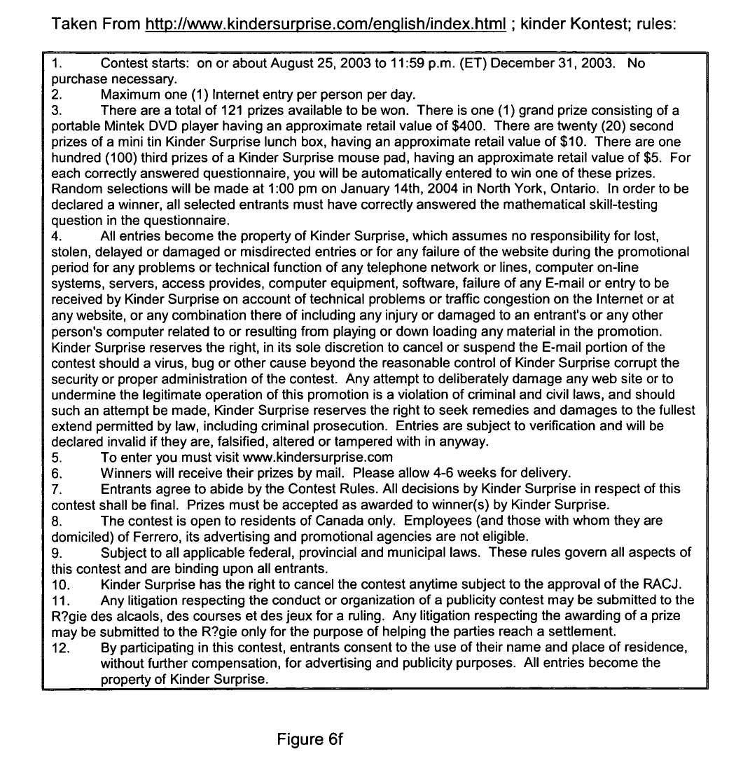

Referring also to FIG. 5, there is schematically illustrated a main menu of a mini-site according to an embodiment of the invention. In this non-limiting and exemplary menu, the sponsor is Kinder Surprise™. In order to ease understanding, this embodiment of the present invention will be presented also with reference to FIGS. 6a-6e, which show web pages available at the official Canadian website of Kinder Surprise (at http://www.kindersurprise.com/english/index.html), and FIG. 6f, that shows the full content of the “Kinder Kontest” rules page as partially shown in FIG. 6c.

The overall look of the main menu 500 is designed to be appealing for the consumers, for example, in a design similar to that of the official Canadian site shown in FIG. 6a. The main menu 500 includes icons 505 “Game 1” and 510 “Game 2”, which offer the user an interactive game (for example, as offered by the icon “Pl@y Online” in FIG. 6a). Also included is icon 515 “Big Prize” that stands for a prize draw or a competition, for example, like the one offered by the icon “Kinder Kontest” in FIG. 6a and in 6b. Icon 520 “Kinder special offer” in FIG. 5 stands for offers like special merchandise or best deals, for example, as offered by the icon “Boutique” in FIG. 6a and in FIG. 6e. Menu 500 also presents icon 525 “Winners” that allow the users to view the winner lists or the highest scores, or the like. Also included is icon 530 “Next Prize” that may present the big prize that will be offered in the upcoming prize draw or competition, in order to encourage the consumer to return to this menu once more.

It should be understood that the present invention is not limited by the design and appearance of the different menus and web pages as discussed above, and many alterations and modifications are possible. Furthermore, the invention is not limited by the incentives and interactive activities that are offered to the consumers.

A mini-site according to the present invention (for example, Menu 500 and the web pages associated therewith) are characterized in that some usage parameters of the mini-site and other mini-sites in the portal 400 are monitored (indicating part of the consumers' activities carried out in that mini site) and controlled such that incentives and promotional content are dynamically and selectively associated throughout the system. In order to demonstrate this feature, reference is again drawn to FIGS. 4, 5 and 6a-6e. Let us assume that Kinder™ offers a DVD player in a contest that opened on Aug. 25, 2003 and ends on Dec. 31, 2003 (see FIG. 6c). This information can be presented not only at the Kinder™ mini-site (i.e. menu 500 in FIG. 5) but also in the main menu 400 (in FIG. 4), for example, by presenting the exemplary message: “Now at Kinder Surprise, the winner takes a portable Mintek™ DVD player!”, (see FIG. 6b), and by this, enhances exposure for Kinder™ and teases consumers to access the Kinder™ mini-site. Let us also assume that shortly after publication of the contest, after just one week, many consumers indeed access the Kinder™ contest. These consumers are now waiting for the end of the competition term (which is December 31) and perhaps will not enter the Kinder™ site until then because no other attraction is available there for them. According to an embodiment of the present invention, the usage of the Kinder™ mini-site is monitored. For example, the system monitors the number of accesses to the site and also the number of participants in the specific contest (this will be presented in greater details further below). The data is then processed and analyzed (this will also be explained further below) and in response, several actions regarding the association of incentives and content can be performed. For example, the following actions are carried out:
presenting different promotional content in the main menu 400 (in FIG. 4). For example, replacing the message “Now at Kinder Surprise, the winner takes a portable Mintek™ DVD player!” with another slogan, say: “Now at Kinder Surprise™, Kinder™ hat at $2 only!”. In this example, a design-related incentive (the banner in the main menu) is associated with the Kinder™ campaign.
updating the Kinder™ mini-site such that the Kinder™ hat is indeed offered for only $2 (instead of $20, see FIG. 6e). In this example, a monetary incentive is associated with the Kinder™ campaign.

Note that the menu 400 does not form part of the Kinder™ mini-site. However, in response to the usage level of the Kinder™ mini-site, incentives presented in the same mini-site (e.g. offering the hat at $2) and in other parts of the systems (e.g. the message in the main menu of the system) are dynamically allocated with promotional content. This novel concept is now demonstrated in another scenario according to which, only a few consumers accessed the Kinder™ site, although the Kinder™ contest is already on. According to an embodiment of the present invention, this information is monitored (as will be explained further below) and in response, exemplary actions are carried out as follows:

At the main menu 400 (in FIG. 4), an offer icon is shown, stating for example: “Now! Visit Kinder Surprise™ and get Mintek™ discount coupon for free!”. Alternatively, the following message can also be presented: “Now! Visit Kinder Surprise™ and automatically be enrolled in today's prize draw!”. In these two examples, design related incentives as well as monetary incentives are associated with the Kinder™ campaign in response to the level of usage of the Kinder™ mini-site.

To summarize the exemplary scenarios discussed above, the system according to an embodiment of the invention provides incentives like monetary awards in interactive games, competitions, and prize draws; discount vouchers and purchase vouchers. The system also provides design related incentives such as banners and icons (e.g. links to interactive activities) in the various menus, and offers interactive activities such as games, prize draws, competitions, registration to consumers' club, accessing sites, etc., which provide appealing user experience and by that serve as incentives by themselves. Each of these incentives is associated with a promotional campaign and can be dynamically and selectively associated with a specific promotional content, based on the usage level of the system or parts thereof.

Note that the in the above discussed examples, in order to enhance the promotional efforts of Kinder™, other incentives, in addition to the original one (namely, the DVD player offered by Kinder™ as a prize), are associated with Kinder™ campaign. In one of the above examples, the incentive, namely discount coupons, relates to a different sponsor (Mintek™) and the other incentive—the automatic enrollment in today's prize draw—is offered by the operator of the system.

As demonstrated above, the present invention provides a powerful tool for enhancing the promotional efforts of sponsors by monitoring the usage level of interactive activities regarding the promotional content and in response, dynamically associating incentives with content. The invention further provides a sophisticated mechanism for financing the promotional efforts. This will now be explained with reference to the above-detailed description.

According to an embodiment of the invention, Kinder™ (the sponsor) can adjust its budget based on the actual usage of sites involved in its campaign. For example, Kinder can decide to allocate additional finance to its on-line campaign in case not enough consumers participate in the contest. In such a case, Kinder™ (i.e. the sponsor itself) finances the association of additional incentives with its promotional content (i.e. the reduction of the price of Kinder™ hat).

According to an embodiment of the present invention, another, second sponsor finances the association of additional incentives with the promotional content of the first sponsor. By one example, discount coupons of Mintek™ are offered to consumers that accessed the Kinder™ mini-site. This allows Mintec™ to participate in the promotional campaign of Kinder™ (and benefit from being associated with a well known brand). This also grants Kinder™ a benefit as it is assumed that in response to Mintec™'s offer, more consumers will visit the Kinder™ site.

By monitoring the actual usage of the mini sites (indicating the actual activities of the consumers) the sponsors can evaluate the success of the campaigns and decide on further financing of such campaigns.

According to another embodiment of the present invention, the association of additional incentives with the promotional content of Kinder™ (e.g. offering automatic enrollment in today's prize draw) is financed by the operator of the system. According to this embodiment, the operator, based on the overall revenues of the system or from its own monetary sources (e.g. by self financing), allocates funds (or in other words, creates a bank) for financing interactive activities, and based on the actual usage of the system or parts thereof, allocates these funds between the different incentives in order to enhance the promotional efforts of the sponsors and the attractiveness of the system itself to sponsors and consumers.

According to an embodiment of the invention, in order to increase consumers' activities in the portal, the operator operates the bank in the following manner: using the payments collected from the sponsors (and perhaps additional funds), an additional, highly appealing incentive (e.g. jackpot) associated with promotional content of several sponsors is offered. For example, a prize draw with a very attractive prize is offered by several sponsors for consumers who accessed the mini sites of all sponsors during a certain period. In another example, the additional prize draw is offered consumers that achieved a predefined activity level.

The operator may use its bank for example in the following manner: The games and competitions offered in the various mini-sites may have hi-score tables presented in the same web pages (or in linked pages) for attracting consumers to play longer to achieve better scores and to beat fellow users. These hi-score tables are associated with small-scale prize draws, open for hi-scorers only, in which prizes are drawn daily, weekly and/or monthly. These prizes may provide an additional incentive for users to play the games and visit the corresponding mini-sites on a daily basis. By this approach, the system provides a community of loyal game players which interact with the system on a regular basis and by that the overall usage of the system is increased.

It is known to monitor usage of web sites such as traffic or file downloading. For example, web statistics programs like OpenWebScope™ available from N.Y.C. Software (Leech Software, Inc.), USA can be used to measure usage parameters indicating user interaction with the system. Such programs typically use log files created at the host server (or other servers) or data gathered from the consumers' computers, to generate usage data such as how many visitors browse a specific site, which search engines or portals directed them to that site, and many other such parameters.

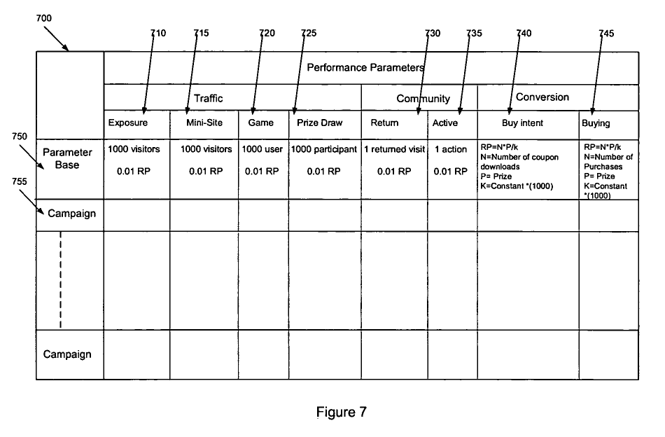

With reference to FIGS. 7 to 9, the following is an explanation of an exemplary scheme of monitoring and analyzing the actual usage of the system, according to an embodiment of the invention. The main idea in this embodiment is to process the usage data in order to rate the usage and generate a rank, based of which the allocation of incentives is controlled. The rating scheme is aimed at rating and ranking each of the promotional campaigns that are operated in the portal in a manner that will allow the sponsors and the operator to enhance the efficiency of the campaigns. As many promotional campaigns are operated simultaneously, there is an advantage in using a common ranking scheme for correlating between the different campaigns. This common rank is noted as URS, Unified Rating Score, and is defined as a weighted function of the usage parameters associated with a specific promotional campaign. The usage parameters are all expressed in unified measure called RP, Rating points.

According to this exemplary scheme, the following usage parameters are considered:

Traffic Parameters
exposure—this parameter relates to the promotional content provided at the main menu of the system, e.g. mini-site icon or banner. The total number of visitors in the main menu is monitored. Each of the campaigns promoted by the content of the main menu (e.g. having a mini site icon) at the time of monitoring is credited with the rating point RP. In this example, exposure of content to 1000 visitors equals 0.01RP.
mini-site entry—this parameter relates to entries to a specific mini-site, and is defined, for example, as the total number of entries to the mini-site from the first time a specific campaign was launched and until the time of monitoring. In this example, each 1000 entries equal 0.01RP.
game—this parameter relates to the total sum of unique consumers (i.e. a single user that has not played this game before) that participated in a specific game. According to this example, several game sessions performed by the same consumer are counted only once, and 1000 consumers playing the game grant the corresponding campaign 0.01RP.
prize draw—this parameter relates to the total number of consumers that participate in a specific prize draw enrollment, wherein each participant grant the corresponding campaign 0.01RP.
   Community Parameters
Return—this parameter relates to the repeated visits of consumers at a specific mini-site. Typically, a ‘return’ is defined as a single user that has returned to the site after at least 24-hours and was previously counted as a ‘unique visitor’. Each additional visit grants the campaign 0.01RP.
Active—this parameter relates to active actions that are carried out by consumers in relation to a mini-site, for example, sending a so-called ‘tell a friend’ message, registering a newsletter, joining forums or chat rooms, answering polls, downloading a ring tone, downloading wallpaper, downloading a screensaver and the like. Each active action grants the campaign 0.01RP.

Conversion
Buy Intent—this parameter relates to actions carried out by consumers that may indicate their intention to purchase the promoted product (or service). Such indicating actions are for example, downloading discount or best-deal coupons. The value of RP's is set according to the relation RP=N*P/1000 wherein N is the number of coupons downloaded by consumers during the period of measurement and P is the price of the corresponding product (or service).
Buying—this parameter relates to the actual act of buying conducted by a consumer, for example using the fully-online scheme described above, or purchasing vouchers with monetary value. The value of RP's is set according to the relation RP=N*P/1000, wherein N denotes the number of products bought and P denotes their price.

Note that other usage parameters can be used for rating, for example: daily activity, countries, hourly summary, monthly summary, authenticated users, most accessed webpages, least accessed webpages, entry pages, exit pages, paths through site, referrer pages, and others.

As mentioned, the URS (Unified Rating Score) is a weighted ranking function of the performance parameters associated with a specific promotional campaign. An exemplary function for the URS is as follow:
URS={RP_{Exposure*}Weight_{Exposure}+RP_{Minisite}*Weight_{Minisitee}+RP_{Game}*Weight_{Game}+RP_{PrizeDraw}*Weight_{PrizeDraw}+RP_{Return}*Weight_{Return}+RP_{Active}*Weight_{Active}+RP_{BuyInternet}*Weight_{BuyIntent}+RP_{Buying}*Weight_{Buying}}/Factor Number (8)

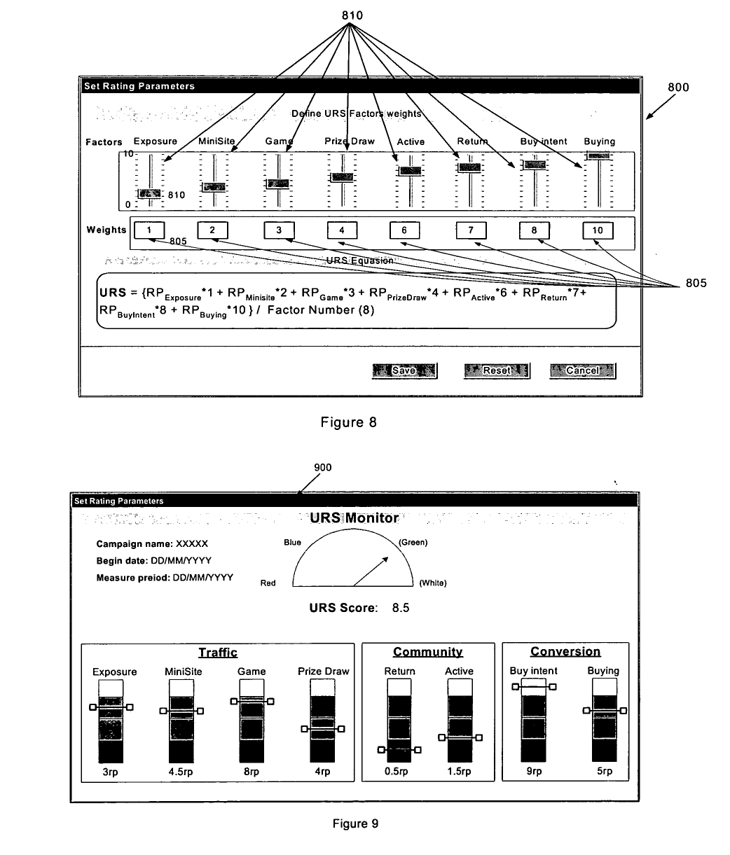

In this example, 8 usage parameters are considered, as discussed above, and each is weighted by using a corresponding weight factor that, in this non limiting example, can be set to be any integer number between 1 and 10. FIG. 8 schematically illustrates an exemplary scheme for defining the usage of a system according to an embodiment of the invention, in a self-explanatory manner. In this example, the ‘conversion’ parameters (i.e. ‘buying’ and ‘buy intent’) are highly considered, and this is achieved by weighting them with factors 10 and 8.

FIG. 7 illustrates schematically and in a self-explanatory manner, an exemplary data structure for storing data relating to the usage of a system according to an embodiment of the invention. Note that the usage data is stored in a manner that facilitates correlation of the data with the corresponding promotional content (e.g. campaign, sponsor). In order to illustrate this, reference is drawn again to the above detailed example of Kinder and Mintek™. Let us assume that Mintek™ runs a promotional campaign by operating its mini-site and also in cooperation with Kinder™ (for example, by offering a DVD player as the big prize in Kinder™'s contest run in the Kinder™ mini-site). Thus, in order to rank the Mintek™ campaign, the level of consumers' activity in both mini sites, Mintek™'s and Kinder™'s, is monitored and analyzed. Note that consumers' activity in the Kinder™ site is rated with reference to the Kinder™ campaign and also with reference to the Mintek™ campaign.

FIG. 8 illustrates schematically and in a self-explanatory manner, an interface for defining a rank for usage of the system according to an embodiment of the invention. FIG. 9 illustrates schematically and in a self-explanatory manner, a simulation of the rank for the usage of a system according to an embodiment of the invention. According to an embodiment of the invention, it is possible to set the URS function according to different set of weight factors, to comply with different promotionalpolicies. FIG. 8 shows an interface 800 having weight windows 805 in which the weight factors for the corresponding usage parameters are shown. Buttons 810 allow changing the settings of the weight factors in an easy and friendly manner, in order to apply or analyze the usage parameters in light of various ranking policies. This is needed as different sponsors have different ranking policies. For example, one sponsor is interested mainly in the ‘buying intent’ parameter wherein another sponsor wishes to focus on games, as the games include important subliminal messages.

According to an embodiment of the invention, the system comprises a sponsor-computer connected to the network, and is further configured to provide as an output the above-mentioned rank and to receive as an input instructions for associating incentives with promotional content. In the above configuration, the sponsor can receive the rank outputted by the system and convey the system instructions for fulfilling an advertising policy which, in turn, will be inputted by the system and used for associating of incentives with promotional content. The sponsor can receive the outputted rank and further information and convey his instructions using e.g. interfaces 800 and 900 as shown in FIGS. 8 and 9. Note that each sponsor is able to set his own campaign policy by setting the weighting factors of the ranking function as discussed above, and defining a rank per campaign (i.e., specific campaign score). The system is able to monitor activities and manage the association of incentives and promotional content based on the Unified Ranking Score (URS), or the specific campaign score, or a combination thereof.

Note that the invention is not limited by the type of usage parameters that are used, and other parameters that have not been described here may be used. Furthermore, the invention is not limited by the specific example of rating and ranking schemes as discussed with reference to FIGS. 7 to 9, and many variations and alterations are possible, without deviating from the scope of the invention.

According to an embodiment of the invention, all mini-sites are run at the host server. According to another embodiment of the invention, some mini-sites (or even all of the mini-sites) are run at a remote computer/s. For example, companies that have relatively large web sites (which may thus be found by users to be intimidating and over-crowded) can use the system of the invention for creating smaller-scaled sites that focus, for example, on a specific product. By one approach, the smaller-scaled site is linked to pages of the large web site, as well as to those of the site of the system of the invention.

According to an embodiment of the present invention, the system of the invention provides positive advertising, one that is welcomed by the user and not imposed upon him as being intrusive. In order to achieve positive advertisement, the menus and pages are e.g. designed to be free of irritating banners. Furthermore, the system of the invention can be integrated with sophisticated registration architectures, like those allowing a user a single registration step for various activities. Note that according to an embodiment of the invention, a single registration step will allow a consumer to participate in activities relating to a variety of sponsors.

According to another embodiment of the present invention, in order to increase the system credibility for the users, the following exemplary activities are carried out: the consumers and sponsors are well informed about how the system works and generates revenue, so they will not feel that they are being tricked or manipulated. Additionally, extensive winner lists are provided, including pictures of previous winners and their personal responses. At any moment users are able to see how many entries are enrolled into each prize draw and its current status. Users are constantly able to track their prize draw entries. The system may not reward the user with prize draw enrollment without providing status tracking and robust proof that such prize draws are indeed being held, and that ordinary winners are being selected and win substantial prizes. Furthermore, various activities are carried out in a secure manner. Specifically, the module for winners' selection in a prize draw is integrated with a hardware-based generator of random numbers. In addition, the system of the present invention can be integrated with sophisticated known per se security technologies.

According to an embodiment of the present invention, the system of the invention is multi-lingual and each user is allowed to select his language of preference. As different countries differ in the definition and regulation of prize draws, the system of the invention is configured to provide a user with interactive activities that comply with the regulations of his citizenship and/or residency. In Israel, for example, a product purchase must be made in order to participate in a prize draw, whereas in the U.S., a purchase is not mandatory for participating in a sweepstakes (the American term for a prize draw). In order for the system of the invention to meet the regulations of various countries where it is deployed, great flexibility is built into the system, to allow defining how consumers are offered incentives.

The invention was mainly described with reference to an Internet-based embodiment of the invention. However the invention is not limited by the type of media it is implemented in and the principles of the invention are equally applicable to other environments (e.g. cable, interactive TV and others), with the necessary adjustments, as will be apparent to those skilled in the art.

Note that the system according to an embodiment of the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A computerized method for providing interactive advertisement, comprising:
a) providing a repertoire of incentives;
b) providing a gateway and at least two mini-sites, each including promotional content associated with at least one incentive from among said repertoire of incentives;
c) dynamically monitoring at least consumer's activities in respect of selected promotional content in at least one of said mini-sites and providing a rank, and depending upon at least said rank, selectively associating at least one incentive with promotional content.

2. A method according to claim 1 wherein said repertoire of incentives includes at least one of: monetary incentives, design-related incentives, activity related incentive.

3. A method according to claim 2 wherein said monetary incentives include at least one of: monetary awards in at least one of: interactive games, competitions and prize draws; discount vouchers; and purchase vouchers.

4. A method according to claim 2 wherein said design-related incentives include at least one of: icons, banners, page design.

5. A method according to claim 2 wherein said design-related incentives are associated with promotional content located in at least one of: said gateway; said mini site; a remote site.

6. A method according to claim 2 wherein said activity related incentives include at least one of: participation in a game, participation in a prize draw, participation in a competitions, registering to consumers' club, accessing a site, downloading a rington, downloading a wallpaper, downloading a screensaver.

7. A method according to claim 1 wherein said consumers' activity includes at least one parameter of: accessing said gateway, accessing said mini site, accessing a remote site, game participation, prize draw participation, returned mini-site entry, active action, action indicating intent to buy, and buying action.

8. A method according to claim 6 wherein said rank is a weighted function of at least said parameters of consumers' activity, wherein each parameter is rated according to a predetermined manner and is weighted by using a predefined weight factor, and wherein said weight factor can be changed on-the-fly.

9. A method according to claim 1 wherein said selectively associating at least one incentive with promotional content includes at least one of:
associating at an incentive with said promotional content, wherein said incentive is already associated with another promotional content;
updating the monetary value of a monetary incentive already associated with said promotional content;
at a site other than said mini-site, allocating an incentive with said promotional content; and
said one incentive replacing an incentive already associated with said promotional content.

10. A method according to claim 9 wherein said monetary incentive is a monetary award or a monetary-equivalent award offered in relation to at least one of: a game, a competition, a prize draw, a discount voucher or a purchase voucher;
and said updating the monetary value of said award includes at least one of:
increasing the monetary value of said award; and
increasing the frequency of winning of said award.

11. A system for providing interactive advertisement, comprising:
a network;
a host computer connected to the network for providing a repertoire of incentives and for providing a gateway and at least two mini-sites, each including promotional content associated with at least one incentive from among said repertoire of incentives;
a consumer computer connected to the network for allowing a consumer performing consumer activities in respect of selected promotional content in at least one of said mini-sites;
a resource management module connectable to said host for dynamically monitoring said consumer's activities and providing a rank, and depending upon at least said rank, selectively associating at least one incentive with promotional content.

12. A system according to claim 12 wherein said network including the Internet.

13. A system according to claim 12 wherein said network including cable network.

14. A system according to claim 12 wherein said network including interactive TV network.

15. A system according to claim 12 wherein said consumer computer is a mobile communication device.

16. A system according to claim 12 wherein said consumer computer is a personal computer.

17. A system according to claim 12 further comprising a sponsor computer connected to the network, said system further configured to provide as an output said rank and is further configured to receive as an input instructions for associating at least one incentive with promotional content.

18. A method for increasing customers' activities in an interactive advertisement portal for fulfilling a promotional campaigns run by at least two sponsors, comprising:
(a) providing a first action enabling a repertoire of incentives;
(b) providing a second action enabling at least two mini-sites; each mini-site including promotional content relating to at least one of said promotional campaigns run by a sponsor, said promotional content being associated with at least one incentive from among said repertoire of incentives;
(c) charging said sponsors for said first action and second action; and
(d) collecting payments from sponsors and based on at least said payments, providing additional monetary incentive and associating said additional monetary incentive with promotional content relating to at least two promotional campaigns.

19. A method according to claim 18 wherein said stage (c) further including:
monitoring consumers' activities in respect of selected promotional content in said mini-sites and charging said sponsors for said second action in dependence with said consumers' activities.

20. A method for increasing customers' activities in an interactive advertisement portal for fulfilling promotional campaigns run by at least one sponsor, comprising:
(a) providing a plurality of mini-sites in said portal; each mini-site associated with at least on of said sponsors and campaigns; mini-site including promotional content associated with at least one incentive from a repertoire of incentives;
(b) charging at least one sponsor for either or both the promotional content and the associated incentive, giving rise to a charge per mini-site;
(c) accumulating said charge per mini-site from selected mini-sites from said plurality of mini-sites, giving rise for a total sum usable for increasing monetary incentives.
